(19) United States
(12) Patent Application Publication
(10) Pub. No.: US 2011/0160418 A1
(43) Pub. Date: Jun. 30, 2011

(54) IMPROVED NVF COPOLYMER PROCESS

(76) Inventors: Richard Vicari, Pearland, TX (US); Florin Barsan, Pearland, TX (US); Kien Van Phung, Pearland, TX (US)

(21) Appl. No.: 12/998,026

(22) PCT Filed: Sep. 11, 2009
(86) PCT No.: PCT/US2009/005098

§ 371 Date: Mar. 10, 2011

Related U.S. Application Data
(60) Provisional application No. 61/096,756, filed on Sep. 12, 2008.

(51) Int. Cl. C08F 226/02

(52) U.S. Cl. 526/312

(57) ABSTRACT

Disclosed herein is a water-soluble copolymer formed by copolymerizing N-vinylformamide and one or more vinyl C₁-C₁₀ alkyl esters, and then hydrolyzing from 30 to 100 mol % of the formyl groups from the copolymerized units to form amino groups and from 30 to 100 mol % of the C₁-C₁₀ alkyl ester groups from the copolymerized units to form hydroxyl groups, wherein the copolymer has a unimodal molecular weight distribution as evidenced by essentially one peak in a gel permeation gradient elution chromatographic analysis. A process to produce the polymer is also disclosed.

### BACKGROUND OF THE INVENTION

The present invention generally relates to a vinyl amine vinyl alcohol copolymer and a method to produce a vinyl amine vinyl alcohol copolymer. More particularly, a truly random vinyl amine vinyl alcohol copolymer and a method to produce a truly random vinyl amine vinyl alcohol copolymer.

Water soluble polymers which contain amine functionality are generally useful in a number of applications. A particularly attractive polymer for certain applications would be a vinyl alcohol copolymer with a low but controllable level of amine functionality.

Previous attempts at preparation of amine functional polyvinyl alcohol (PVOH) include hydrolyzing copolymers of vinyl acetate and either N-vinyl-O-t-butyl carbamate or N-vinylacetamide. The carbamate monomer is prepared by a long and costly synthesis and is reported to hydrolyze to a highly toxic aziridine in the presence of water. In both cases the poly(vinyl acetate) component was hydrolyzed with methanolic or aqueous base. In the carbamate case, treatment of an aqueous solution of the poly(vinyl alcohol)-co-poly(N-vinyl-O-t-butyl carbamate) with acid gave the poly(vinyl alcohol)-co-poly(vinylamine) acid salt. Hydrolysis of the poly(N-vinylacetamide) is known to require strong acid at high temperatures. Both approaches produce a relatively dilute aqueous solution of the polymer which is expensive to store or ship or requires expensive additional steps to isolate the polymer from the solution. The aqueous solution also contains substantial amounts of frequently undesirable salts or acid. Other methods known in the art include copolymerization of vinyl acetate with N-vinylacetamide and copolymer hydrolysis, probably to the poly(vinyl alcohol)-co-poly(N-vinylacetamide; and copolymerization of vinyl acetate with N-vinyl-O-t-butyl carbamate and copolymer hydrolysis.

U.S. Pat. No. 4,255,548 discloses ethylene/vinylamine copolymers which are obtained by copolymerization of ethylene with N-vinylformamide and elimination of all formyl groups from the copolymer by the action of hydrochloric acid.

Poly(vinylamine) copolymers are made indirectly by (co)polymerization of a derivative of vinylamine, such as N-vinylformamide, and subsequent removal of the derivatizing group. Previous methods for conversion of poly(N-vinylformamide) (pNVF) or analogous polymeric intermediates to pVA entail hydrolysis with either strong base (U.S. Pat. No. 4,393,174) or acid (U.S. Pat. No. 4,808,683). Japan Kokai Tokkyo Koho, Jp 61 118406 (1984) discloses the preparation of pVA by treatment of pNVF with a mixture of aqueous ammonia or alkylamine at room temperature, followed by hydrolysis with aqueous sodium or potassium hydroxide.

U.S. Pat. No. 4,421,602 discloses the production of copoly (N-vinylformamide vinylamine) by reaction of pNVF with acid or base. Aqueous sodium or potassium hydroxides are preferred and the use of ammonia or amines is disclosed, but not exemplified. In the latter instance, removal of formamide groups as the corresponding monomeric formamides is indicated. In each case, inorganic coproducts are formed in conjunction with pVA; base hydrolysis leads to alkali metal salts of the derivatizing group (e.g., sodium or potassium formate), while acid hydrolysis gives the corresponding salt of pVA and formic acid. Neutralization provides pVA, accompanied by a salt of the acid used for hydrolysis and (unless formic acid was removed) a formate salt. Although some applications of pVA are insensitive to the presence of inorganics, many, including those in adhesives and coatings, require essentially salt-free pVA. Separation of these coproducts from pVA has been accomplished by traditional routes such as precipitation, selective extraction, or ultrafiltration. In all instances, however, preparation of salt-free pVA entails tedious removal and disposal of stoichiometric quantities of an inorganic coproduct.

Similar hydrolytic procedures have also been used to generate amine functional copolymers from the corresponding NVF copolymers. However, partial conversion of any additional hydrolytically labile functionality in the copolymer is often observed. Thus, hydrolysis of copolymers of NVF with (meth)acrylamides (U.S. Pat. No. 4,808,683), (meth)acrylonitrile (U.S. Pat. Nos. 4,957,977 and 5,064,909), or (meth)acrylates (U.S. Pat. No. 5,037,927) under acidic conditions yields amine functional polymers which also contain carboxylate groups. U.S. Pat. No. 4,921,621 reports comparable results with basic hydrolyses of NVF-acrylamide copolymers. U.S. Pat. No. 5,281,340 discloses amidine-containing polymers which are the products of acidic hydrolysis of NVF-(meth)acrylamide copolymers. U.S. Pat. No. 4,774,285 discloses water soluble polymers which are obtained by hydrolysis of copolymers of NVF with a variety of comonomers, e.g., vinyl esters, N-vinylpyrrolidinone, (meth)acrylates, under strongly acidic or basic conditions. Copolymerized vinyl esters are also hydrolyzed, especially under basic conditions.

U.S. Pat. No. 4,943,676 discloses the thermolysis of pNVF as a route to pVA. High temperatures (>200° C.) are required, conversions to pVA are low to moderate, and difficultly soluble, crosslinked products are obtained. While the last disadvantage may be overcome by inclusion of water, the resulting products still contain formate salts.

U.S. Pat. No. 5,491,199 is generally directed to salt-free poly(vinylamine) and vinylamine copolymers formed by heating N-vinylformamide or N-vinylformamide copolymers to a temperature from about 50° C. to 225° C. in an aqueous medium in the presence of a catalyst comprising a transition metal which is a member of either the first transition series or of Group VIII.

U.S. Pat. No. 6,559,227 is generally directed to a process for producing a powdered water-soluble polymer comprising hydrolyzing a copolymer comprising an N-vinylamide unit and a vinyl acetate unit while dispersed in water under a basic condition and then washing the resulting powdered water-soluble polymer with at least one washing liquid selected from an alcohol, water at 20° C. or lower, and salt water.

While numerous referenced are directed to polyvinyl amine copolymers (pVAm), their production and use, pVAm copolymers known in the art are not truly random copolymers, which results in various odor causing impurities to be formed, in aqueous 4% solutions that do not fully dissolve, in polymers having bi or multimodal polymer distributions, in amidine ring formation within the polymer, in less than optimal reactive polymers, in polymers having color bodies, and the like. PolyVAm copolymers which are truly random copolymers remain elusive in the art.

As can be seen, there is a need for pVAm copolymers which are truly random, which fully dissolve in 4% aqueous solutions at room temperature, and which are more reactive than known pVAm polymers. There is also s need for pVAm copolymers which do not have odor causing impurities, bi or multimodal polymer distributions, amidine ring formation, color bodies, and/or the like.

### SUMMARY OF THE INVENTION

In one aspect of the present invention, a water-soluble copolymer comprises a water soluble copolymer formed by copolymerizing:

(a) from 99 to 1 mol % of N-vinylformamide and

(b) from 1 to 99 mol % of one or more vinyl C₁-C₁₀ alkyl esters, and then hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer has a unimodal molecular weight distribution as evidenced by essentially one peak in a gel permeation gradient elution chromatographic analysis.

In another aspect of the present invention, a water-soluble copolymer comprises a copolymer formed by copolymerizing:

(a) from 99 to 1 mol % of N-vinylformamide and

(b) from 1 to 99 mol % of one or more vinyl C₁-C₁₀ alkyl esters, and the hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer has a unimodal molecular weight distribution as evidenced by a 4 wt % aqueous solution having a turbidity of less than about 100 turbidity units.

In still another aspect of the present invention, a water-soluble copolymer comprises a copolymer formed by copolymerizing
(a) from 99 to 1 mol % of N-vinylformamide and
(b) from 1 to 99 mol % of one or more vinyl C₁-C₁₀ alkyl esters, and then hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer is essentially free of amidine rings as evidenced by a lack of an absorption in a ¹³C NMR spectrum of the copolymer consistent with an amidine carbon atom absorption.

In yet still another aspect of the present invention, a process to produce a water-soluble copolymer comprises the steps of:

a) charging a first portion of a total amount of N-vinylformamide into a reactor;

b) charging a first portion of a total amount of at least one vinyl C₁-C₁₀ alkyl ester into the reactor;

c) continuously feeding a first portion of a total amount of a free radical polymerization catalyst at a first catalyst flow rate into the reactor;

d) contacting the first portion of N-vinylformamide, the first portion of at least one vinyl C₁-C₁₀ alkyl ester, in the presence of the free radical polymerization catalyst under polymerization conditions for a first period of time;

e) after the first period of time, continuously feeding for a second period of time, a second portion of the n-vinylformamide at a n-vinylformamide flow rate into the reactor while simultaneously feeding a second portion of at least one vinyl C₁-C₁₀ alkyl ester into the reactor at an ester flow rate, while simultaneously feeding a second portion of the free radical polymerization catalyst at a second catalyst flow rate into the reactor under polymerization conditions until the total amount of the N-vinylformamide, the total amount of the vinyl C₁-C₁₀ alkyl ester, and the total amount of the free radical polymerization catalyst have been fed into the reactor;

f) followed by contacting for a third period of time, the n-vinylformamide and the at least one vinyl C₁-C₁₀ alkyl ester in the presence of the free radical polymerization catalyst in the reactor under polymerization conditions to produce an intermediate copolymer comprising polyvinyl formamide and one or more polyvinyl C₁-C₁₀ alkyl esters, wherein the third period of time expires when the solids content of the intermediate copolymer in the reactor is greater than or equal to about 20 wt % and less than or equal to about 70 wt %; followed by

g) saponifying the copolymer to produce polyvinyl alcohol-co-vinyl formamide

h) hydrolyzing the intermediate copolymer under either acidic or basic conditions to produce the water soluble copolymer.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a gel permeation gradient elution chromatographic analysis chromatogram of a comparative copolymer which does not have a unimodal molecular weight distribution;

FIG. 2 is a gel permeation gradient elution chromatographic analysis chromatogram of an inventive copolymer having a unimodal molecular weight distribution;

FIG. 3 is a gel permeation gradient elution chromatographic analysis chromatogram of an inventive copolymer having a unimodal molecular weight distribution;

FIG. 4 is a gel permeation gradient elution chromatographic analysis chromatogram of an inventive copolymer having a unimodal molecular weight distribution;

FIG. 5 is a gel permeation gradient elution chromatographic analysis chromatogram of an inventive copolymer having a unimodal molecular weight distribution;

FIG. 6 is a gel permeation gradient elution chromatographic analysis chromatogram of an inventive copolymer having a unimodal molecular weight distribution;

FIG. 7 is a gel permeation gradient elution chromatographic analysis chromatogram of an inventive copolymer having a unimodal molecular weight distribution;

FIG. 8 is a gel permeation gradient elution chromatographic analysis chromatogram of an inventive copolymer having a unimodal molecular weight distribution;

FIG. 9 is a diagram of an embodiment of the instant process; and

FIG. 10 shows a ¹³C NMR spectrum showing both the presence and the absence of an amidine ring in the instant polymer.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

In the following description, numerous specific details are set forth to provide a thorough understanding of the present invention. However, it will be obvious to those skilled in the art that the present invention may be practiced without such specific details. In other instances, well-known devices have been shown in block diagram form in order not to obscure the present invention in unnecessary detail. For the most part, details unnecessary to obtain a complete understanding of the present invention have been omitted in as much as such details are within the skills of persons of ordinary skill in the relevant art.

Terms used herein include a reactor, which is defined as any container(s) in which a chemical reaction occurs. As used herein, the new numbering scheme for the Periodic Table Groups are used as in CHEMICAL AND ENGINEERING NEWS, 63(5), 27 (1985). Polymer may be used to refer to homopolymers, copolymers, interpolymers, terpolymers, etc. Likewise, a copolymer may refer to a polymer comprising at least two monomers, optionally with other monomers.

When a polymer is referred to as comprising a monomer, the monomer is present in the polymer in the polymerized form of the monomer or in the derivative form of the monomer. Likewise, when catalyst components are described as comprising neutral stable forms of the components, it is well understood by one skilled in the art, that the ionic form of the component is the form that reacts with the monomers to produce polymers.

As used herein, structural formulas are employed as is commonly understood in the chemical arts; lines (“—”) used to represent associations between atoms, as well as the phrases “associated with”, “bonded to” and “bonding”, are not limited to representing a certain type of chemical bond, as these lines and phrases are meant to represent a “chemical bond”; a “chemical bond” defined as an attractive force between atoms that is strong enough to permit the combined aggregate to function as a unit, or “compound”.

Broadly, the present invention generally provides a water-soluble copolymer comprising a copolymer formed by copolymerizing:

(a) from 99 to 1 mol % of N-vinylformamide and

(b) from 1 to 99 mol % of one or more vinyl C₁-C₁₀ alkyl esters, and then hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer has a unimodal molecular weight distribution. In an embodiment, the unimodal molecular weight distribution is evidenced by essentially one peak in a gel permeation gradient elution chromatographic analysis and/or wherein a 4% solution of the copolymer has an APHA color value of less than or equal to about 100 APHA units determined according to ASTM D1209 or a comparable method, and/or wherein the copolymer is essentially free of amidine rings as evidenced by a lack of an absorption in a ¹³C NMR spectrum of the copolymer consistent with an amidine carbon atom absorption. A process for producing such a polymer is also disclosed.

The copolymers preferably have the following specifications, 4% viscosity of 5-10 cps, amine content of 8-12 mol %, ash≦2 wt % and volatiles<5%. The new process developed differs from the prior art especially in the way the polymerizations is carried out. First, the two monomers used, vinyl acetate and N-vinyl Formamide (NVF), are both added to the reactor over time to achieve the desired loading of the monomers into the polymer chain. A second stream adds the initiator in methanol which in this case is Trigonox 23 (a free-radical peroxydicarbonate type initiator). The delayed feed of the two monomers results in a more uniformed incorporation of the monomers along the polymer chain. Once the polymerization is complete the copolymer is stripped of free monomer then saponified using NaOH. The resulting slurry of polymer in methanol/methyl acetate (by-product of saponification) is filtered to remove the solvents especially the methyl acetate which will interfere with the hydrolysis step that follows. The dried polymer is then placed into fresh methanol, an excess of NaOH is added, and then the slurry is heated to complete the hydrolysis of the amide functionality to the free amine. The improved process produced a clear, non-hazy, odorless solution (both the saponified and hydrolyzed samples).

The prior art process adds the NVF monomer in two portions to the reactor that contains the vinyl acetate, methanol and AIBN as initiator. AIBN is a free-radical diazo type initiator. The decomposition products from the AIBN initiator are considered hazardous and toxic. The polymerization is run to very high overall conversion to minimize the residual vinyl acetate and NVF monomers. This results in non-uniform incorporation of the monomers along the polymer chain; this is commonly called compositional drift. The copolymer is then subjected to saponification and hydrolysis, same as above.

The effect of this drift was observed in the formation of haze when the polymer was stirred in water at room temperature (both the saponified and hydrolyzed samples). In addition, the instant polymers are more reactive compared to the prior art since amidine rings are not present in the polymers and thus more amine groups are available for reactions.

### Polymer Composition

In an embodiment, the instant copolymer comprises vinyl alcohol moieties or residues and vinyl amine moieties or residues. The instant polymer is referred to herein simply as the polyvinyl amine copolymer, and/or by the abbreviation PVAm.

In an embodiment, the polyvinyl amine copolymer comprises vinyl amine residues and vinyl alcohol residues as a random copolymer. In general, the polymer is the result of a process which includes the steps of hydrolyzing a copolymer comprising an N-vinylamide unit and one or more vinyl C₁-C₁₀ esters, preferably vinyl acetate units while dispersed in water under a basic condition. The N-vinylamide unit can be provided, for instance, from N-vinylformamide, N-vinylacetamide, and/or any suitable amide containing functional group. Production of the polyvinyl amine copolymer includes a hydrolysis step, wherein a copolymer of vinyl acetate and the N-vinylamide undergo hydrolysis to a degree of at least about 30 mol %, preferably 40 mol %, preferably 50 mol %, preferably 60 mol %, preferably 70 mol % or more, preferably at least about 80 mol % or more, preferably at least about 90 mol % or more, preferably at least about 95 mol % or more, with a copolymer having essentially 100% hydrolysis being still more preferred.

The hydrolysis may be carried out under acidic or basic conditions. The basic condition can be created by adding a strong alkali, such as a caustic alkali. Examples of a caustic alkali include caustic soda or caustic potash. The alkali is usually added in an amount from 0.1 to 10 equivalents, such as from 0.5 to 5 equivalents per equivalent of the total monomers.

After hydrolysis, the resultant slurry may be cooled and the solid can be separated from the liquid by any suitable means. The process may also include a washing step wherein the collected polymer is washed to remove any impurities. Washing can be effected with a washing liquid comprising at least one member selected from 1) an alcohol, 2) cold water at 20° C. or lower, or 3) salt water in order to remove the impurities in the polymer with a minimized polymer loss.

The instant polyvinyl amine copolymer preferably has the structure:

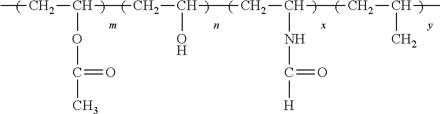

where m is 0 to 30 mole %;

n is 1 to 99 mole %;

x is 0 to 30 mole %; and

y is 1 to 99 mole %.

The resulting copolymer can have any suitable molecular weight, such as an average molecular weight ranging from about 10,000 to about 200,000. Suitable free radical initiators for the polymerization reaction include organic peroxides, redox catalysts, and azo compounds which decompose under polymerization conditions to give free radicals.

The polyvinyl amine copolymer of the instant application comprises residues of vinyl amine and vinyl alcohol. In an embodiment, the polyvinyl amine copolymer comprises greater than or equal to about 0.5 mol % vinyl amine, and less than or equal to about 99 mol % vinyl amine, based on the total amount of the polyvinyl amine copolymer present. Within this range, the polyvinyl amine copolymer preferably comprises greater than or equal to about 1 mol % vinyl amine, preferably greater than or equal to about 2 mol %, preferably greater than or equal to about 3 mol %, preferably greater than or equal to about 4 mol %, preferably greater than or equal to about 5 mol %, preferably greater than or equal to about 6 mol %, preferably greater than or equal to about 7 mol %, preferably greater than or equal to about 8 mol %, preferably greater than or equal to about 9 mol %, preferably greater than or equal to about 10 mol %, preferably greater than or equal to about 15 mol %, preferably greater than or equal to about 20 mol %, preferably greater than or equal to about 25 mol %, preferably greater than or equal to about 30 mol %, preferably greater than or equal to about 35 mol %, preferably greater than or equal to about 40 mol %, preferably greater than or equal to about 45 mol %, preferably greater than or equal to about 50 mol % polyvinyl amine, based on the total amount of the polyvinyl amine copolymer present.

Also within this range, the polyvinyl amine copolymer preferably comprises less than or equal to about 90 mol % vinyl amine, preferably less than or equal to about 80 mol %, preferably less than or equal to about 70 mol %, preferably less than or equal to about 60 mol %, preferably less than or equal to about 50 mol %, preferably less than or equal to about 30 mol %, preferably less than or equal to about 25 mol %, preferably less than or equal to about 20 mol %, preferably less than or equal to about 15 mol %, preferably less than or equal to about 10 mol %, preferably less than or equal to about 9 mol %, preferably less than or equal to about 8 mol %, preferably less than or equal to about 7 mol %, preferably less than or equal to about 6 mol %, preferably less than or equal to about 5 mol %, preferably less than or equal to about 4 mol %, preferably less than or equal to about 3 mol %, preferably less than or equal to about 2 mol % polyvinyl amine, based on the total amount of the polyvinyl amine copolymer present.

In one embodiment, the weight average molecular weight of the polyvinyl amine copolymer may be greater than or equal to about 5,000 g/mol, and less than or equal to about 2,000,000 g/mol. Within this range, the weight average molecular weight of the polyvinyl amine copolymer preferably is greater than about 10,000, more preferably greater than about 20,000, more preferably greater than about 30,000, more preferably greater than about 40,000, more preferably greater than about 50,000, more preferably greater than about 60,000, more preferably greater than about 70,000, more preferably greater than about 80,000, more preferably greater than about 90,000, more preferably greater than about 100,000, more preferably greater than about 150,000 g/mol.

Also within this range the weight average molecular weight of the polyvinyl amine copolymer preferably is less than about 1,500,000, more preferably less than about 1,000,000, more preferably less than about 500,000, more preferably less than about 100,000, more preferably less than about 90,000, more preferably less than about 80,000, more preferably less than about 70,000, more preferably less than about 60,000, more preferably less than about 50,000, more preferably less than about 40,000, more preferably less than about 20,000 g/mol.

The instant polyvinyl amine copolymer has and essentially unimodal molecular weight distribution. This may be characterized in a number of ways.

In an embodiment, the polyvinyl amine copolymer may have a polydispersity, determined as the weight average molecular weight (Mw) divided by the number average molecular weight (Mn) of from 1 to about 200. Within the range, the polyvinyl amine copolymer may have a polydispersity of greater than or equal to about 2, more preferably greater than or equal to about 3, more preferably greater than or equal to about 4, more preferably greater than or equal to about 5, more preferably greater than or equal to about 6, more preferably greater than or equal to about 7, more preferably greater than or equal to about 8, more preferably greater than or equal to about 9, more preferably greater than or equal to about 10, more preferably greater than or equal to about 15, more preferably greater than or equal to about 20, more preferably greater than or equal to about 25, more preferably greater than or equal to about 30, more preferably greater than or equal to about 35, more preferably greater than or equal to about 40.

Also within this range, the polyvinyl amine copolymer may have a polydispersity of less than or equal to about 45, more preferably less than or equal to about 40, more preferably less than or equal to about 35, more preferably less than or equal to about 30, more preferably less than or equal to about 25, more preferably less than or equal to about 20 more preferably less than or equal to about 15, more preferably less than or equal to about 10, more preferably less than or equal to about 9, more preferably less than or equal to about 15, more preferably less than or equal to about 8, more preferably less than or equal to about 7, more preferably less than or equal to about 6, more preferably less than or equal to about 5, more preferably less than or equal to about 4.

In an embodiment, the instant polyvinyl amine copolymer has a unimodal molecular weight distribution as evidenced by essentially one peak in a gel permeation gradient elution chromatographic analysis. A suitable gel permeation gradient elution chromatographic analysis may be found in Waters Corporation Publication No. WA10192 entitled, “Waters Alliance System: Gradient Analysis of Polymer Blends” Published by Waters Corporation, Milford, Mass. Available at: http://www.waters.com/waters/library.htm?cid=511436&lid=1536540

In an embodiment, the gel permeation gradient elution chromatographic analysis includes the following steps and conditions:

HPLC conditions:

10 minute run time with a 5 minute post-run equilibrium.

Solvent starts with 99% Water/1% acetonitrile (ACN) at time 0 minutes, and finishes with 80% ACN and 20% of 99% Water/1% ACN at 10 minutes. The ramp is uniform with the time.

Flow: 1.0 ml/min

Column: PLRP-S, 4000A, 8 Micron, 50×4.6 mm, temperature at 40° C.

Injection volume: 20 Microliters

Sample flows into an evaporative light scattering detector (ELS) after passing through the HPLC column.

ELS conditions:

Nitrogen gas flow at 2.0 ml/min

Nebulizer temperature at 90° C.

Evaporation temperature at 120° C.

Data acquisition is through Atlas chromatography system.

Sample preparation takes a 1-2 percent solution and heats at 85° C. for an hour while stirring, then cool back down to room temperature (i.e., 25° C.)

Filter through a 0.45 Micron filter into a crimp vial.

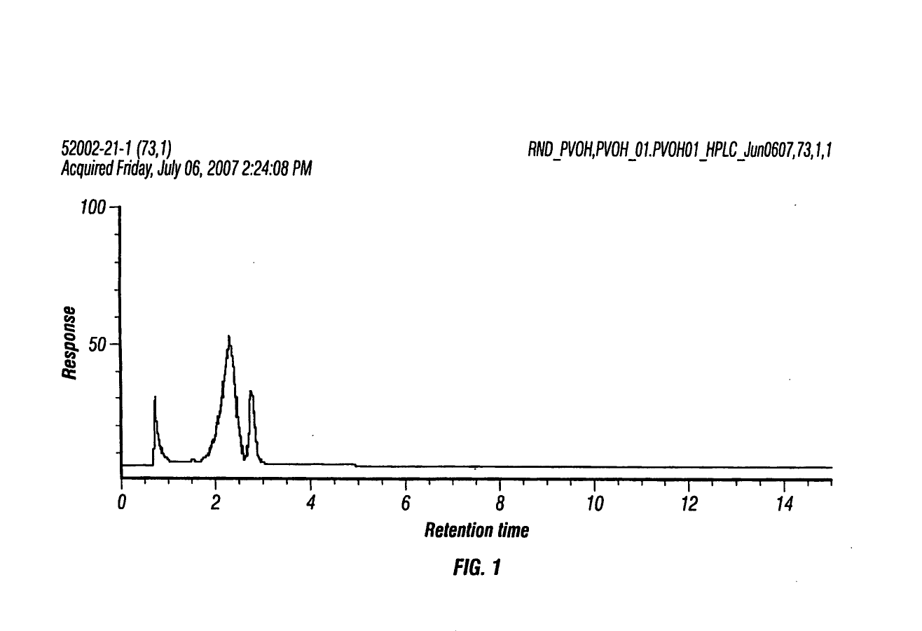

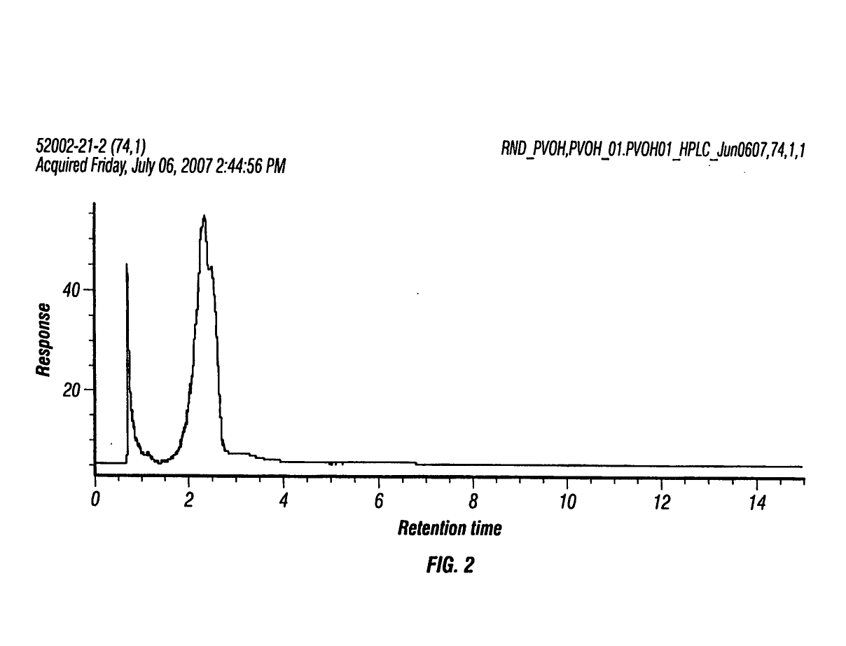

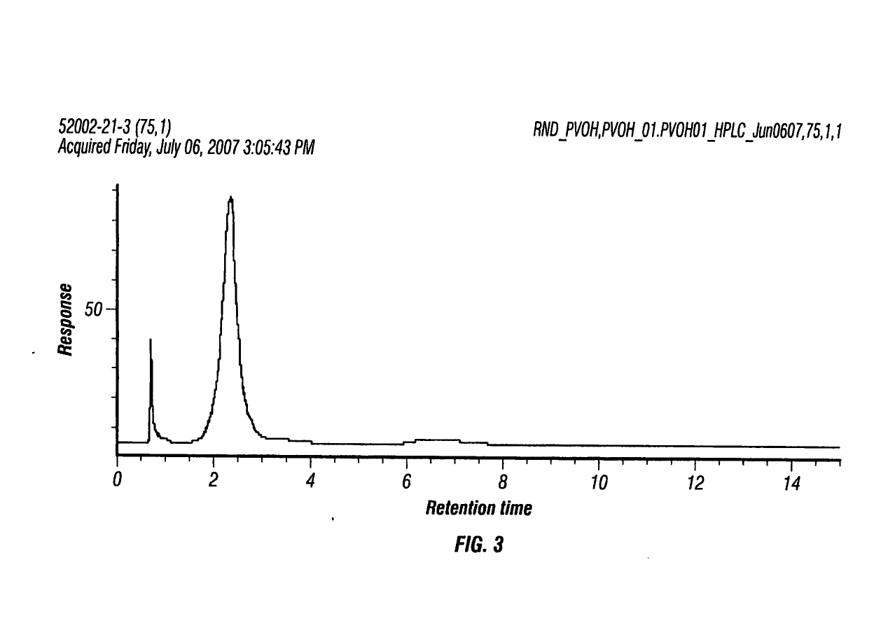

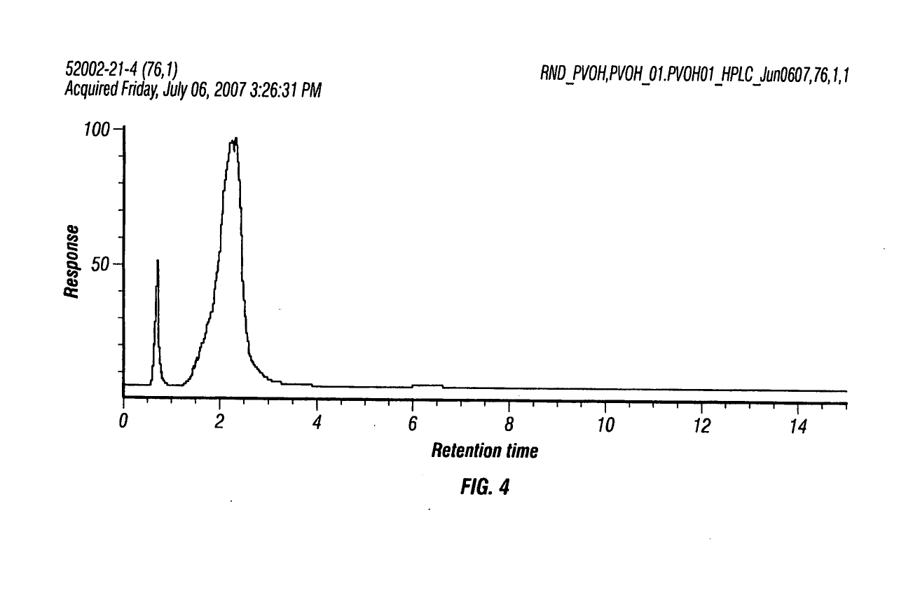

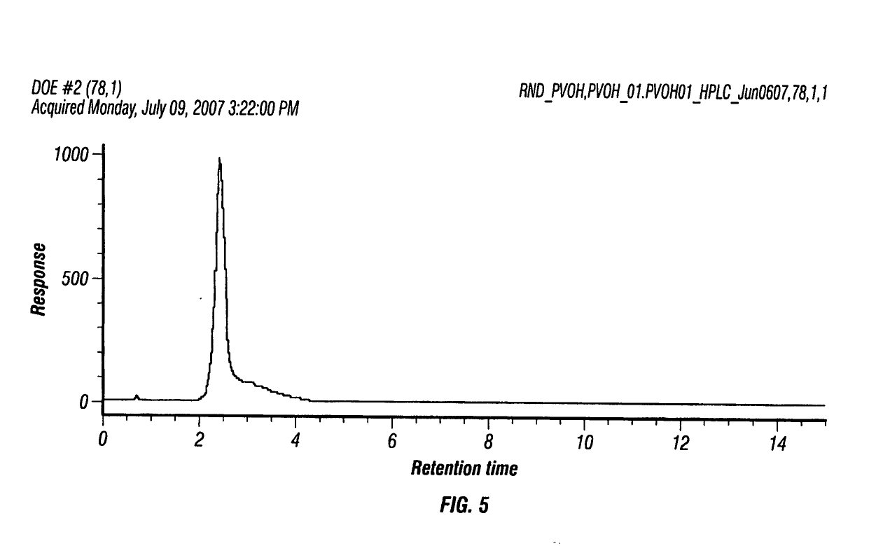

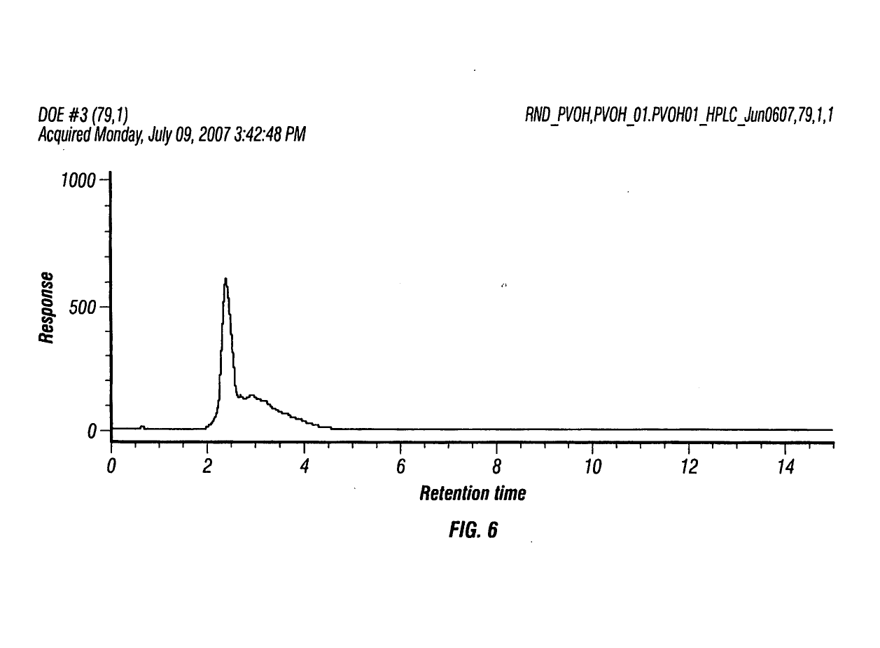

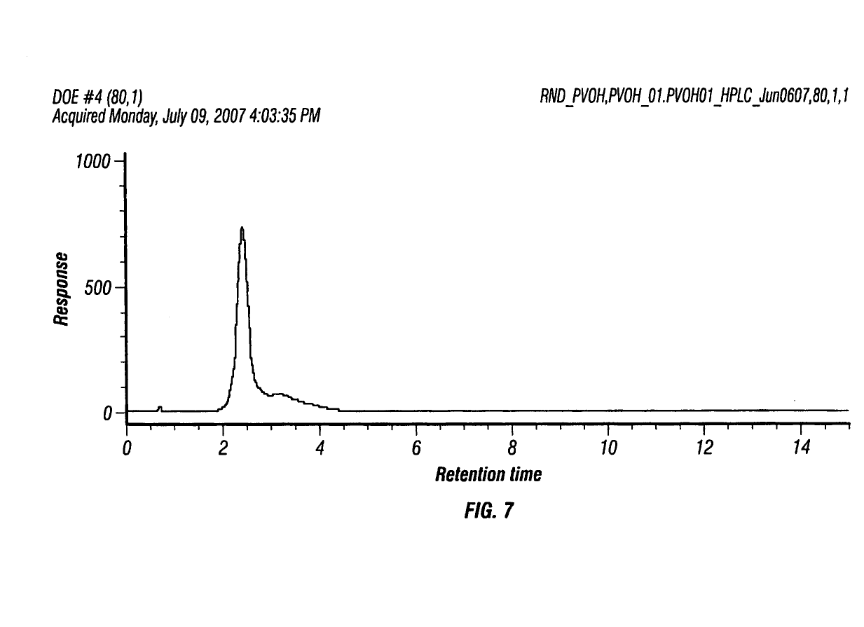

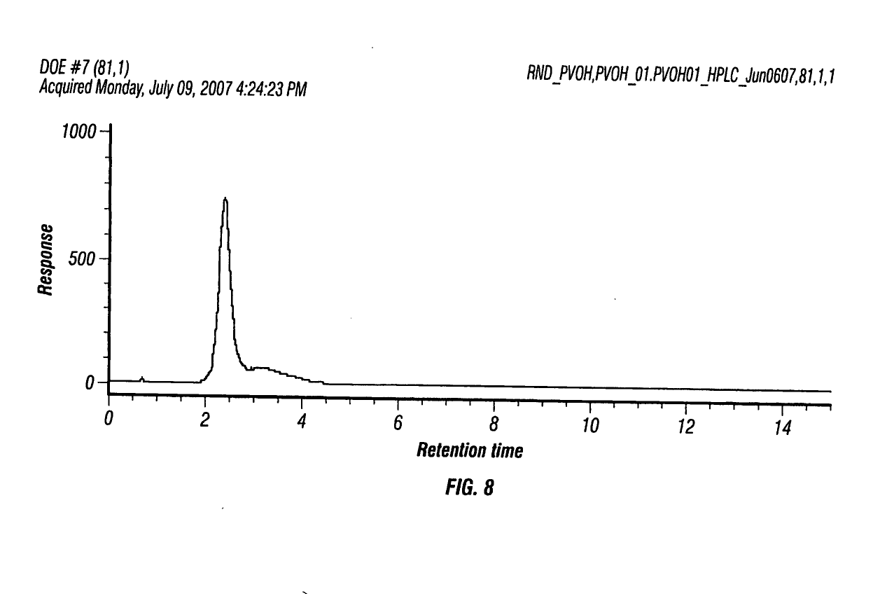

FIG. 1 shows a comparative permeation gradient elution chromatographic analysis wherein two peaks are discernable. For purposes herein, FIGS. 2, 3, 4, 5, 6, 7, and 8 show an inventive copolymer having a unimodal molecular weight distribution as evidenced by essentially one peak in a gel permeation gradient elution chromatographic analysis. Importantly, the single peak refers to the analyte and not to any salt and/or solvent peaks in the chromatogram, (e.g., typically seen in the Figures at or about retention time 0.75.) In addition, a slight tailing shoulder on the peak as seen in FIGS. 5-7 is for purposes herein, representative of a unimodal molecular weight distribution, and likely do to overloading of the column in the Figures.

In an embodiment, instant polyvinyl amine copolymer has a unimodal molecular weight distribution as evidenced by a 4 wt % aqueous solution having a turbidity of less than about 100 turbidity units. For purposes herein, turbidity units indicate Nephelometric Turbidity Units (NTU). Turbidity is measured using a nephelmeter, the use of which is commonly known to one of minimal skill in the art.

In an embodiment, the turbidity of a 4 wt % solution is preferably less than or equal to about 95, preferably less than or equal to about 90, preferably less than or equal to about 85, preferably less than or equal to about 80, preferably less than or equal to about 75, preferably less than or equal to about 70, preferably less than or equal to about 65, preferably less than or equal to about 60, preferably less than or equal to about 55, preferably less than or equal to about 50, preferably less than or equal to about 45, preferably less than or equal to about 40, preferably less than or equal to about 35, preferably less than or equal to about 30, preferably less than or equal to about 25, preferably less than or equal to about 20, with less than or equal to about 15 NTU being still more preferred.

In an embodiment, the polyvinyl amine copolymer is essentially free of amidine rings. This indicates a random distribution of the amide in the intermediate copolymer prior to hydrolysis and thus, a random polyvinyl amine copolymer. The amine copolymer is essentially free of amidine rings as evidenced by a lack of an absorption in a ¹³C NMR spectrum of the copolymer consistent with an amidine carbon atom absorption.

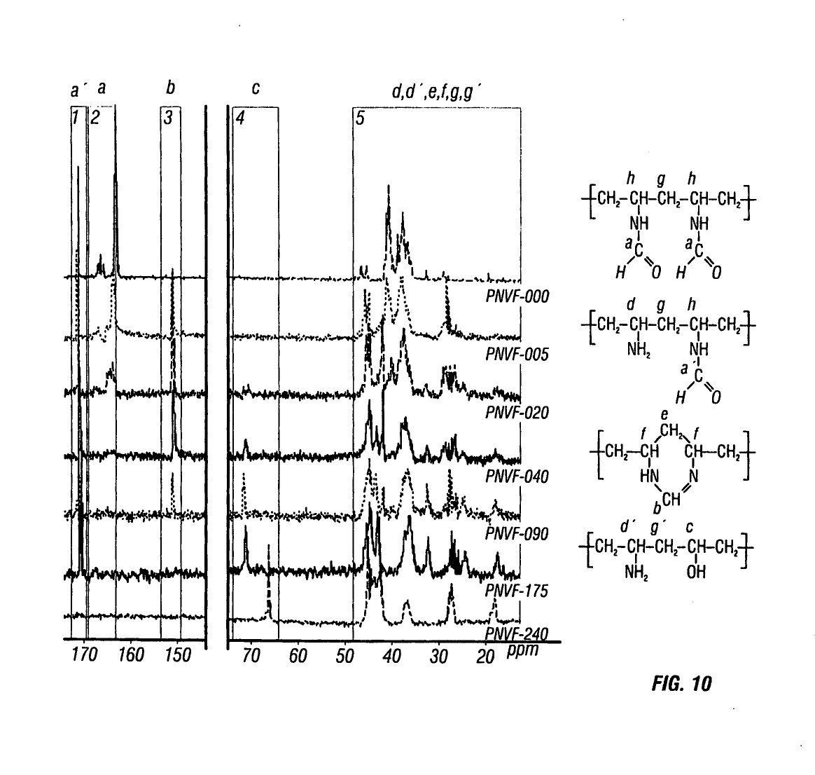

The process by which amidine rings form in the copolymer is represented as follows:

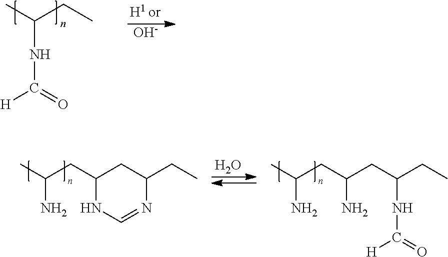

Wherein amide moieties in the copolymer react via intramolecular reaction to produce the amidine rings. The presence of such rings may be determined by ¹³C NMR as shown in FIG. 10 and as described as follows:

Accordingly, in an embodiment, the presence of an absorption in the range of 150 ppm may indicate an amidine ring is present in a copolymer. In an embodiment, the instant copolymer is essentially free of amidine rings as evidenced by a lack of an absorption in a ¹³C NMR spectrum of the copolymer consistent with an amidine carbon atom absorption (e.g., 150 ppm or equivalent.) For more information see Witek, Ewa, Pazdro, Marcin and Bortel, Edgar (2007) ‘Mechanism for Base Hydrolysis of Poly(N-vinylformamide)’, Journal of Macromolecular Science, Part A, 44:5, 503-507

DOI: 10.1080/10601320701235461 URL:http://dx.doi.org/10.1080/10601320701235461

In an embodiment the instant copolymer has less color than a copolymer produced according to the prior art. This is thought to be the result of a more random copolymer of the instant invention, as compared to copolymers known in the art. In an embodiment, a 4% solution of the copolymer has an APHA color value of less than or equal to about 100 APHA units, determined according to ASTM D1209 or a comparable method. Preferably, a 4% solution of the copolymer has an APHA color value of less than or equal to about 90, preferably less than or equal to about 80, preferably less than or equal to about 70, preferably less than or equal to about 60, preferably less than or equal to about 50, preferably less than or equal to about 40, preferably less than or equal to about 30, preferably less than or equal to about 20, preferably less than or equal to about 10, preferably less than or equal to about 5 APHA units determined according to ASTM D1209 or a comparable method.

The instant copolymer also has less of an odor than do comparative polyvinyl amine copolymers. However, odor is essentially impossible to quantify and thus, a general statement of reduced odor compared to known copolymers is offered herein.

### Other Polymers

In addition, the instant polyvinyl amine copolymer may be combined with various homopolymers and/or copolymers including, but not limited to water-soluble copolymers of N-vinyl pyridine, ethylenically unsaturated mono, di, or trialkyl ammonium salts, such as vinylbenzene trimethyl ammonium chloride, aminoethyl acrylate hydrochloride, N-methylamino ethylacrylate, N,N-dimethylaminoethyl methacrylate, N,N-dimethylaminomethyl-N-acrylamide, N,N-dimethylaminoethyl-N-acrylamide and the like. Preferred are polymers containing a plurality of aminoalkyl nitrogen-substituted acrylamide mers, preferably wherein the aminoalkyl substituent is hydrophilic, e.g., contains less than about 8 carbons.

In an embodiment, the polyvinyl amine copolymer may comprise various levels of hydrolysis with regard to the amide groups (hydrolyzed to amines) and/or the ester groups (hydrolyzed to alcohols.) Suitable levels of hydrolysis include a level of hydrolysis preferably greater than or equal to about 85% up to about 99.9%, with a level of hydrolysis of between 86.0-89.0% preferred, 91.0-93.0% still more preferred, 92.0-94.0% still more preferred, 95.5-96.5% still more preferred, 92.5-95.5% still more preferred, 98.0-98.8% still more preferred, with greater than or equal to about 99.3+ being still more preferred.

The viscosity of a 4% solution of the instant polyvinyl amine copolymer may be from about 2 to about 80 cps at 20 C. In an embodiment, the polyvinyl amine copolymer has a viscosity of about 45-72 cps, a degree of polymerization of about 1600 to 2200, and a Mw of about 146,000 to 186,000. In another embodiment, the polyvinyl amine copolymer has a viscosity of about 5-6 cps, a degree of polymerization of about 350 to 650, and a Mw of about 31,000 to 50,000. In another embodiment, the polyvinyl amine copolymer has a viscosity of about 22-30 cps, a degree of polymerization of about 1000 to 1500, and a Mw of about 85,000 to 124,000. In a preferred embodiment, the polyvinyl amine copolymer has a viscosity of about 3-4 cps, a degree of polymerization of about 150 to 300, and a Mw of about 13,000 to 23,000.

Further additives may also be included in the composition to impart properties desired for the particular article being manufactured. Such additives include, but are not necessarily limited to, fillers, pigments, dyestuffs, antioxidants, stabilizers, processing aids, plasticizers, fire retardants, anti-fog agents, scavengers, and the like.

In an embodiment, the viscosity of a 4% aqueous solution of the instant polyvinyl amine copolymer is preferably about 5 to about 200 cps at 20° C. Within this range, the viscosity is preferably greater than or equal to about 10, preferably greater than or equal to about 20, preferably greater than or equal to about 30, preferably greater than or equal to about 40, preferably greater than or equal to about 50, preferably greater than or equal to about 60, preferably greater than or equal to about 70 cps at 20 ° C. Also within this range, the viscosity is preferably less than or equal to about 190, preferably less than or equal to about 180, preferably less than or equal to about 170, preferably less than or equal to about 160, preferably less than or equal to about 150, preferably less than or equal to about 140, preferably less than or equal to about 130 cps at 20° C.

The instant polyvinyl amine copolymer may have a total solids content of about 1 to about 90 wt %. Within this range, the total solids content is preferably greater than or equal to about 2, preferably greater than or equal to about 5, preferably greater than or equal to about 10, preferably greater than or equal to about 15, preferably greater than or equal to about 20, preferably greater than or equal to about 25, preferably greater than or equal to about 30%. Also within this range, the total solids content is preferably less than or equal to about 80, preferably less than or equal to about 85, preferably less than or equal to about 70, preferably less than or equal to about 60, preferably less than or equal to about 50, preferably less than or equal to about 40, preferably less than or equal to about 35 wt %.

### Process

The reactivity of the vinyl esters is less than the reactivity of the vinyl amides. When the vinyl esters are in excess, the vinyl amides are consumed in the polymerization leaving polymers which are essentially polyvinyl esters homopolymers. For example, the reactivity constant under polymerization conditions for vinyl acetate (r₁) is estimated to be 0.09, in comparison to the reactivity constant of N-vinyl formamide under the same conditions (r₂) which is estimated to be 9.54. Other estimates include r₁=0.4 compared to r₂=6.6; and r₁=0.34 compared to r₂=6.2. Applicants have unexpectedly discovered that a truly random copolymer can be produced if the feed rate of the reactants, the feed rate of the catalyst, and the finishing “temper” time of the reaction are controlled for a particular temperature. This tripartite control results in the formation of a random copolymer without the formation of vinyl amine precursor blocks which upon hydrolysis, result in amidine rings forming in the copolymer, and without the formation of polyvinyl acetate copolymers which upon hydrolysis results in polyvinyl alcohol copolymers.

Accordingly, in an embodiment, a process to produce a water-soluble copolymer comprising the steps of:

a) charging a first portion of a total amount of N-vinylformamide into a reactor;

b) charging a first portion of a total amount of at least one vinyl C₁-C₁₀ alkyl ester into the reactor;

c) continuously feeding a first portion of a total amount of a free radical polymerization catalyst at a first catalyst flow rate into the reactor;

d) contacting the first portion of N-vinylformamide, the first portion of at least one vinyl C₁-C₁₀ alkyl ester, in the presence of the free radical polymerization catalyst under polymerization conditions for a first period of time;

e) after the first period of time, continuously feeding for a second period of time, a second portion of the n-vinylformamide at a n-vinylformamide flow rate into the reactor while simultaneously feeding a second portion of at least one vinyl C₁-C₁₀ alkyl ester into the reactor at an ester flow rate, while simultaneously feeding a second portion of the free radical polymerization catalyst at a second catalyst flow rate into the reactor under polymerization conditions until the total amount of the N-vinylformamide, the total amount of the vinyl C₁-C₁₀ alkyl ester, and the total amount of the free radical polymerization catalyst have been fed into the reactor;

f) followed by contacting for a third period of time, the n-vinylformamide and the at least one vinyl C₁-C₁₀ alkyl ester in the presence of the free radical polymerization catalyst in the reactor under polymerization conditions to produce an intermediate copolymer comprising polyvinyl formamide and one or more polyvinyl C₁-C₁₀ alkyl esters, wherein the third period of time expires when the solids content of the intermediate copolymer in the reactor is greater than or equal to about 20 wt % and less than or equal to about 70 wt %; followed by

g) hydrolyzing the intermediate copolymer under either acidic or basic conditions to produce the water soluble copolymer.

In an embodiment, the copolymerization is carried out in a solvent or diluent, preferably methanol. In an alternative embodiment, the copolymerization is carried out in an aqueous solution.

The hydrolysis may be carried out by contacting the intermediate copolymer with an acid or in the alternative; the hydrolysis is carried out by contacting the intermediate copolymer with a base, preferably NaOH.

The free radical polymerization catalyst is preferably a peroxide, more preferably an organic peroxide. Suitable organic peroxides include ketone peroxides e.g., Butanox and Cyclonox products (Akzo Nobel), Diacyl Peroxides e.g., Perkadox products (Akzo Nobel), Peresters e.g., t-butylperbenzoate (Trigonox C, Akzo Nobel), and the like; Perketals e.g., (Trigonox 22, Akzo Nobel), and the like, and various other peroxides including cumylhydroperoxides, percarbonates, and the like, with Trigonox 23 (Akzo Nobel), being most preferred.

The reaction temperatures are preferably at reflux of the system, typically less than 100° C., preferably less than 90° C., preferably less than 80° C., preferably less than 70° C., with a reaction temperature of about 65° C. being more preferred. The process may be carried out at, above, or below atmospheric pressure as required.

In an embodiment, the first period of time is preferably between about 50 minutes and 500 minutes once the reaction conditions are at polymerization conditions. Within this range, the first period of time is preferably greater than or equal to about 60 minutes, preferably greater than or equal to about 70 minutes, preferably greater than or equal to about 80 minutes, preferably greater than or equal to about 90 minutes, preferably greater than or equal to about 100 minutes, preferably greater than or equal to about 110 minutes, preferably greater than or equal to about 120 minutes, preferably greater than or equal to about 130 minutes, preferably greater than or equal to about 140 minutes, preferably greater than or equal to about 150 minutes, preferably greater than or equal to about 160 minutes, preferably greater than or equal to about 170 minutes, preferably greater than or equal to about 180 minutes, preferably greater than or equal to about 190 minutes, preferably greater than or equal to about 200 minutes, preferably greater than or equal to about 250 minutes, preferably greater than or equal to about 300 minutes, preferably greater than or equal to about 350 minutes, preferably greater than or equal to about 400 minutes.

Also within this range, the first period of time is preferably less than or equal to about 450 minutes, preferably less than or equal to about 400 minutes, preferably less than or equal to about 350 minutes, preferably less than or equal to about 300 minutes, preferably less than or equal to about 250 minutes, preferably less than or equal to about 200 minutes, preferably less than or equal to about 150 minutes, preferably less than or equal to about 100 minutes.

In an embodiment, the first portion of the N-vinylformamide and/or the at least one vinyl C₁-C₁₀ alkyl ester preferably represents about 10% to about 90% of the total amount required. Within this range, the first portion is preferably at least about 20%, preferably at least about 30%, preferably at least about 40%, preferably at least about 50%, preferably at least about 60%, preferably at least about 70%, preferably at least about 80% of the total amount required. Also within this range, the first portion is preferably less than about 80%, preferably less than about 70%, preferably less than about 60%, preferably less than about 50%, preferably less than about 40%, preferably less than about 30%, preferably less than about 20% of the total amount required.

In an embodiment, the first catalyst flow rate is equal to the second catalyst flow rate, and is continuous throughout the polymerization process until the total amount of the catalyst has been added.

In an embodiment, the mol ratio of the catalyst (corrected for activity) to the reactants (both the amide and the ester combined), which ratio is referred to herein as C/V, is preferably about 0.001 to about 0.1. Within this range, the C/V ratio is preferably greater than or equal to about 0.002, preferably greater than or equal to about 0.003, preferably greater than or equal to about 0.004, preferably greater than or equal to about 0.005, preferably greater than or equal to about 0.006, preferably greater than or equal to about 0.007, preferably greater than or equal to about 0.008, preferably greater than or equal to about 0.009, preferably greater than or equal to about 0.01, preferably greater than or equal to about 0.02, preferably greater than or equal to about 0.03, preferably greater than or equal to about 0.04, preferably greater than or equal to about 0.05, preferably greater than or equal to about 0.06, preferably greater than or equal to about 0.07, preferably greater than or equal to about 0.08, preferably greater than or equal to about 0.09.

Also within this range, the C/V ratio is preferably less than or equal to about 0.095, preferably less than or equal to about 0.085, preferably less than or equal to about 0.075, preferably less than or equal to about 0.065, preferably less than or equal to about 0.055, preferably less than or equal to about 0.045, preferably less than or equal to about 0.035, preferably less than or equal to about 0.025, preferably less than or equal to about 0.015, preferably less than or equal to about 0.009, preferably less than or equal to about 0.008, preferably less than or equal to about 0.007, preferably less than or equal to about 0.006, preferably less than or equal to about 0.005.

In an embodiment, the mol ratio of the amide to the ester, which ratio is referred to herein as M/V, is preferably about 0.01 to about 1. Within this range, the M/V ratio is preferably greater than or equal to about 0.02, preferably greater than or equal to about 0.03, preferably greater than or equal to about 0.04, preferably greater than or equal to about 0.05, preferably greater than or equal to about 0.06, preferably greater than or equal to about 0.07, preferably greater than or equal to about 0.08, preferably greater than or equal to about 0.09, preferably greater than or equal to about 0.1, preferably greater than or equal to about 0.2, preferably greater than or equal to about 0.3, preferably greater than or equal to about 0.4, preferably greater than or equal to about 0.5, preferably greater than or equal to about 0.6, preferably greater than or equal to about 0.7, preferably greater than or equal to about 0.8, preferably greater than or equal to about 0.9.

Also within this range, the M/V ratio is preferably less than or equal to about 0.95, preferably less than or equal to about 0.85, preferably less than or equal to about 0.75, preferably less than or equal to about 0.65, preferably less than or equal to about 0.55, preferably less than or equal to about 0.45, preferably less than or equal to about 0.35, preferably less than or equal to about 0.25, preferably less than or equal to about 0.15, preferably less than or equal to about 0.09, preferably less than or equal to about 0.08, preferably less than or equal to about 0.07, preferably less than or equal to about 0. 06, preferably less than or equal to about 0.05.

In an embodiment, the third period of time preferably expires when the solids content of the intermediate copolymer in the reactor is greater than or equal to about 20 wt %, and less than or equal to about 70 wt %. Within this range, the third period of time preferably expires when the solids content of the intermediate copolymer in the reactor is greater than or equal to about 30 wt %, preferably 40 wt %, with 50 wt % being more preferred. Also within this range, the third period of time preferably expires when the solids content of the intermediate copolymer in the reactor is less than or equal to about 65 wt %, preferably less than or equal to about 55 wt %, with less than or equal to about 45 wt % being more preferred.

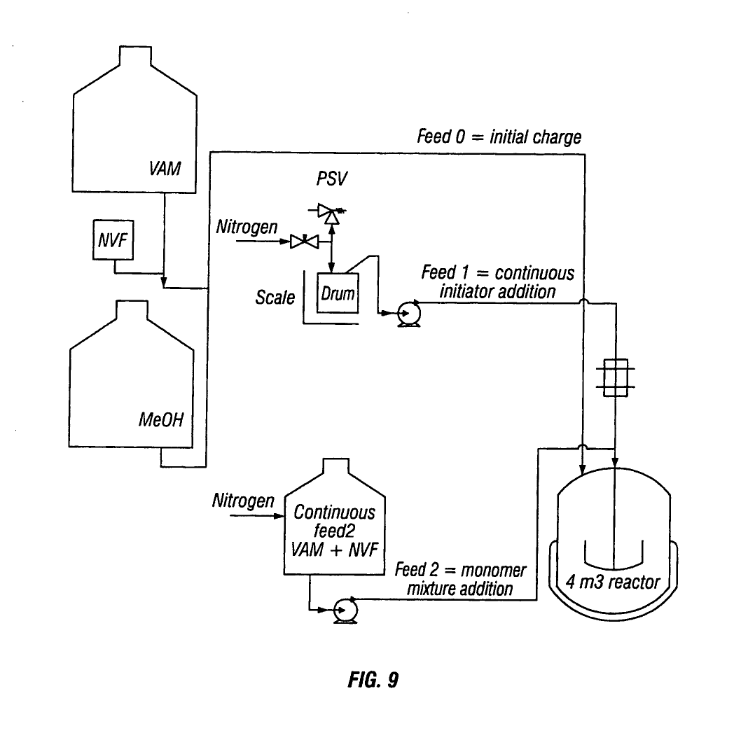

FIG. 9 depicts in block form, an outline of the instant process.

### EXAMPLES

Testing was conducted to determine the optimum conditions to produce the instant polymer. Continuous feeds for monomer and catalyst were carried out through two dosage pumps (see FIG. 9). An additional vessel was used to make-up the catalyst suspension/solution in Methanol. This drum was equipped with two bongs: first for a Nitrogen flex tubing plus a PSV vent valve: On the second bong—a dip-tube for the pump suction tubing. Initiator feed 1 was carried out through a dosage pump.

The instant process used a constant reactor temperature (at 64° C.) and atmospheric pressure.
1. M/V at 0.55 with an overall monomer concentration of 64.5% and C/V at 0.0048. Semibatch addition: Initial charge+two continuous feeds. Total reaction time: six hours (three hrs each for catalyst and monomer feeds to be added and three hours post polymerization for monomer.) Batch cycle time is nine hours.

Addition order for a batch size of 1414 kg:
1. Add initial charge (half of the total charge) and heat up to reflux (64° C.). The VAM concentration in initial charge is 53.2% (M/V=0.74)

| | |
|---|---|
| VAM | 438 kg |
| NVF | 14 kg |
| MeOH | 397 kg |

2. Add continuous feed 1: Perkadox 16S catalyst solution in Methanol.

1. Perkadox16/MeOH 4.32 kg/99 kg (concentration=4.2%) Addition of catalyst solution (feed 1) is done over three ours with a mass addition rate of 0.59 kg/min (this is very small, ˜0.66 L/min)

2. After 30 minutes after the start of feed 1 start adding continuous feed 2 without interrupting feed 1. Feed 2 contains VAM and NVF

| | |
|---|---|
| M/V = | 0.23 (feed 2) |
| C/V = | 0.008 |
| VAM | 382 kg |
| NVF | 70 kg |
| Total Vinyl feed rate = | 2.51 kg/min (2.8 L/min) |

While the reaction time is six hours (three hours during continuous feed, two and three hours of during the final polymerization) the overall batch cycle will be around nine hours: 1 initial charge+1 heat-up+6 reaction time+1 empty time.

Polymerization Control:

The control of the product viscosity and composition is based on:

Changing the ratio of Perkadox 16 initiator to the total amount of vinyl monomer (C/V).

Changing the ratio of methanol to total amount of vinyl monomer (M/V).

Changing the ratio of NVF relative to vinyl acetate (NVF/V)

Paste Striping

Unreacted VAM stripping is proposed to be done using the current 4 m3 reactors vacuum stripping system until reaching ˜2% un-reacted VAM after dilution with methanol.

Saponification

Not changed from current processes in the art

Lodige Hydrolysis

Not changed from current processes in the art

Methanol Wash of the Sodium Acetate and Sodium Formate Salts.

Not changed from current processes in the art

Mass Balance for the Process:

Total size of the batch is 1414 kg. Catalyst solution is prepared by mixing calculated quantity (4.32 kg) of Perkadox 16 with 99 Kg MeOH. This recipe is for the solution polymerization carried out in methanol in 4 m³ reactors.

### Samples:

The following procedure was used:
1. Charge initial charge to Pk1 (mixing)
2. Heat initial charge to set temperature (by controlling pressure)
3. Start delay feed of monomers and initiator (feed rate set by DOE)
4. Continue post reaction (duration set by DOE)
5. Start moving the reaction mixture by gear pump to PK2, 10 min before the end of post-reaction (PK2 contains 0.2 g DEHA in 100 MeOH)
6. After all the mixture from PK1 is moved to PK2, take a sample from PK2 to determine the conversion (% solid).
7. Remove residual VAM by stripping column.
8. Determine residual vinyl by bromine titration and by head space.
9. Determine compositional homogeneity by ELS.

Detailed Procedure for Run Order #1

Sample DOE 1:

| FD (delay feed) time: | 6 | hrs |
|---|---|---|
| Post reaction time: | 3 | hrs |
| C/V: | 0.007 | |
| M/V: | 0.6 | |
| Temperature: | 80° | C. |
| Assumed conversion in all cases: | 55% | solid |

At an M/V = 0.6 the weight composition of
MeOH to total vinyl will be:

| Total: | 1200 | g |
|---|---|---|
| MeOH | 450 g (split into 500 g for | |
| | initial charge and 100 g for | |
| | initiator solution feed) | |
| VAM | 683 | g |
| NVF | 67 | g |

Initial Charge:

| | |
|---|---|
| VAM | 455 g |
| NVF | 12 g |
| MeOH | 375 g |

Monomer Delay:

| | | |
|---|---|---|
| VAM | 228 | g |
| NVF | 55 | g |
| Feed rate: | 0.79 | g/min |

Initiator Delay:

| | | |
|---|---|---|
| Trigonox 23 | 5.3 | g |
| Methanol | 75 | g |
| Feed rate: | 0.22 | g/min. |

Sample DOE 2

DOE input variables:

| FD (delay feed) time: | 2 | hrs |
|---|---|---|
| Post reaction time: | 3 | hrs |
| C/V: | 0.0038 | |
| M/V: | 0.4 | |
| Temperature: | 80 | |
| Total: | 1200 | g |

At an M/V = 0.4, the ratio of MeOH to monomers is:

| | | |
|---|---|---|
| Monomers | 855 | g |
| VAM | 788 | g |
| NVF | 67 | g |
| MeOH | 345 | g |

Initial Charge:

| | |
|---|---|
| VAM | 525 g |
| NVF | 12 g |
| MeOH | 270 g |

Monomers Delay:

| | | |
|---|---|---|
| VAM | 263 | g |
| NVF | 55 | g |
| Feed rate: | 2.65 | g/min |

Initiator Delay:

| | | |
|---|---|---|
| Trigonox 23 | 3.2 | g |
| MeOH | 75 | g |
| Feed rate: | 0.65 | g/min |

Sample DOE 3

DOE input variables:

| FD (delay feed) time: | 2 | hrs |
|---|---|---|
| Post reaction time: | 3 | hrs |
| C/V: | 0.007 | |
| M/V: | 0.4 | |
| Temperature: | 60° | C. |

At an M/V = 0.4, the ratio of MeOH to monomers is:

| | | |
|---|---|---|
| Monomers | 855 | g |
| VAM | 788 | g |
| NVF | 67 | g |
| MeOH | 345 | g |

Initial Charge:

| | |
|---|---|
| VAM | 525 g |
| NVF | 12 g |
| MeOH | 270 g |

Monomers Delay:

| | | |
|---|---|---|
| VAM | 263 | g |
| NVF | 55 | g |
| Feed rate: | 2.65 | g/min |

Initiator Delay:

| | | |
|---|---|---|
| Trigonox 23 | 6 | g |
| MeOH | 75 | g |
| Feed rate: | 0.65 | g/min |

Sample DOE 4

DOE input variables:

| FD (delay feed) time: | 4 | hrs |
|---|---|---|
| Post reaction time: | 2 | hrs |
| C/V: | 0.0054 | |
| M/V: | 0.5 | |
| Temperature: | 70 | C. |

At an M/V = 0.5:

| | | |
|---|---|---|
| Total: | 1200 | g |
| Total Monomers | 800 | g |
| VAM | 733 | g |
| NVF | 67 | g |
| MeOH | 400 | g |

Initial Charge:

| VAM | 489 g |
|---|---|
| NVF | 12 g |
| MeOH | 325 |

Monomers Delay:

| | | |
|---|---|---|
| VAM | 244 | g |
| NVF | 55 | g |
| Feed rate: | 1.25 | g/min |

Initiator Delay:

| | | |
|---|---|---|
| Trigonox 23 | 4.3 | g |
| MeOH | 75 | g |
| Feed rate: | 0.33 | g/min |

Sample DOE 5

DOE input variables:

| FD (delay feed) time: | 4 | hrs |
|---|---|---|
| Post reaction time: | 2 | hrs |
| C/V: | 0.0054 | |
| M/V: | 0.5 | |
| Temperature: | 70° | C. |

At an M/V = 0.5:

| | | |
|---|---|---|
| Total: | 1200 | g |
| Total Monomers | 800 | g |
| VAM | 733 | g |
| NVF | 67 | g |
| MeOH | 400 | g |

Initial Charge:

| VAM | 489 g |
|---|---|
| NVF | 12 g |
| MeOH | 325 |

Monomers Delay:

| | | |
|---|---|---|
| VAM | 244 | g |
| NVF | 55 | g |
| Feed rate: | 1.25 | g/min |

Initiator Delay:

| | | |
|---|---|---|
| Trigonox 23 | 4.3 | g |
| MeOH | 75 | g |
| Feed rate: | 0.33 | g/min |

Sample DOE 6

DOE input variables:

| FD (delay feed) time: | 2 | hrs |
|---|---|---|
| Post reaction time: | 3 | hrs |
| C/V: | 0.0038 | |
| M/V: | 0.4 | |
| Temperature: | 80° | C. |
| Total: | 1200 | g |

At an M/V = 0.4, the ratio of MeOH to monomers is:

| | | |
|---|---|---|
| Monomers | 855 | g |
| VAM | 788 | g |
| NVF | 67 | g |
| MeOH | 345 | g |

Initial Charge:

| | |
|---|---|
| VAM | 525 g |
| NVF | 12 g |
| MeOH | 270 g |

Monomers Delay:

| | | |
|---|---|---|
| VAM | 263 | g |
| NVF | 55 | g |
| Feed rate: | 2.65 | g/min |

Initiator Delay:

| | | |
|---|---|---|
| Trigonox 23 | 6 | g |
| MeOH | 75 | g |
| Feed rate: | 0.22 | g/min |

Sample DOE 7

DOE input variables:

| FD (delay feed) time: | 2 | hrs |
|---|---|---|
| Post reaction time: | 1 | hr |
| C/V: | 0.0038 | |
| M/V: | 0.6 | |
| Temperature: | 80° | C. |
| We need to make some assumption on | 55% | solid |
| conversion (without it, it will be | | |
| impossible to calculate the composition | | |
| of NVF). Assumed conversion in all cases: | | |

At an M/V = 0.6 the weight composition of
MeOH to total vinyl will be:

| Total: | 200 | g |
|---|---|---|
| MeOH | 450 g (split into 500 g for | |
| | initial charge and 100 g for | |
| | initiator solution feed) | |
| VAM | 683 | g |
| NVF | 67 | g |

Initial Charge:

| | |
|---|---|
| VAM | 455 g |
| NVF | 12 g |
| MeOH | 375 g |

Monomer Delay:

| | | |
|---|---|---|
| VAM | 228 | g |
| NVF | 55 | g |
| Feed rate: | 2.36 | g/min |

Initiator Delay:

| | | |
|---|---|---|
| Trigonox 23 | 2.85 | g |
| Methanol | 75 | g |
| Feed rate: | 0.65 | g/min. |

Sample DOE 8

DOE input variables:

| FD (delay feed) time: | 4 | hrs |
|---|---|---|
| Post reaction time: | 2 | hrs |
| C/V: | 0.0054 | |
| M/V: | 0.5 | |
| Temperature: | 70° | C. |

At an M/V = 0.5:

| | | |
|---|---|---|
| Total: | 1200 | g |
| Total Monomers | 800 | g |
| VAM | 733 | g |
| NVF | 67 | g |
| MeOH | 400 | g |

Initial Charge:

| VAM | 489 g |
|---|---|
| NVF | 12 g |
| MeOH | 325 |

Monomers Delay:

| | | |
|---|---|---|
| VAM | 244 | g |
| NVF | 55 | g |
| Feed rate: | 1.25 | g/min |

Initiator Delay:

| | | |
|---|---|---|
| Trigonox 23 | 4.3 | g |
| MeOH | 75 | g |
| Feed rate: | 0.33 | g/min |

Detailed Procedure for Run Order #9

DOE input variables:

| FD (delay feed) time: | 6 | hrs |
|---|---|---|
| Post reaction time: | 3 | hrs |
| C/V: | 0.0038 | |
| M/V: | 0.6 | |
| Temperature: | 60° | C. |
| We need to make some assumption on | 55% | solid |
| conversion (without it, it will be | | |
| impossible to calculate the composition | | |
| of NVF). Assumed conversion in all cases: | | |

At an M/V = 0.6 the weight composition of
MeOH to total vinyl will be:

| Total: | 1200 | g |
|---|---|---|
| MeOH | 450 g (split into 500 g for | |
| | initial charge and 100 g for | |
| | initiator solution feed) | |
| VAM | 683 | g |
| NVF | 67 | g |

Initial Charge:

| | |
|---|---|
| VAM | 455 g |
| NVF | 12 g |
| MeOH | 375 g |

Monomer Delay:

| | | |
|---|---|---|
| VAM | 228 | g |
| NVF | 55 | g |
| Feed rate: | 0.95 | g/min |

Initiator Delay:

| | | |
|---|---|---|
| Trigonox 23 | 2.85 | g |
| Methanol | 75 | g |
| Feed rate: | 0.22 | g/min. |

Detailed Procedure for Run Order #10

DOE input variables:

| FD (delay feed) time: | 6 | hrs |
|---|---|---|
| Post reaction time: | 1 | hr |
| C/V: | 0.0038 | |
| M/V: | 0.4 | |
| Temperature: | 60° | C. |
| Total: | 200 | g |

At an M/V = 0.4, the ratio of MeOH to monomers is:

| | | |
|---|---|---|
| Monomers | 855 | g |
| VAM | 788 | g |
| NVF | 67 | g |
| MeOH | 345 | g |

Initial Charge:

| | |
|---|---|
| VAM | 525 g |
| NVF | 12 g |
| MeOH | 270 g |

Monomers Delay:

| | | |
|---|---|---|
| VAM | 263 | g |
| NVF | 55 | g |
| Feed rate: | 2.65 | g/min |

Initiator Delay:

| | | |
|---|---|---|
| Trigonox 23 | 3.25 | g |
| MeOH | 75 | g |
| Feed rate: | 0.22 | g/min |

Detailed Procedure for Run Order #11

DOE input variables:

| FD (delay feed) time: | 2 | hrs |
|---|---|---|
| Post reaction time: | 1 | hr |
| C/V: | 0.007 | |
| M/V: | 0.6 | |
| Temperature: | 60° | C. |

At an M/V = 0.6

| | | |
|---|---|---|
| Total Monomers | 750 | g |
| VAM | 683 | g |
| NVF | 67 | g |
| MeOH | 450 | g |

Initial Charge:

| | |
|---|---|
| VAM | 455 g |
| NVF | 12 g |
| MeOH | 375 g |

Monomers Delay:

| | | |
|---|---|---|
| VAM | 228 | g |
| NVF | 55 | g |
| Feed rate: | 2.36 | g/min |

Initiator Delay:

| | | |
|---|---|---|
| Trigonox 23 | 5.25 | g |
| MeOH | 75 | g |
| Feed rate: | 0.65 | g/min |

Worksheet Summary (L12):

Total chemicals: 1200 g

Total VAM splits at a ratio of two to one for initial and delay charges.

| Run | | | | FD | RT | Initial charge | Delay | Delay | catalyst |
|---|---|---|---|---|---|---|---|---|---|
| # | C/V | M/V | ° C. | (hr) | (hr) | MeOH/VAM/NVF | VAM/NVF | g/min | g/min |
| 1 | 0.007 | 0.6 | 80 | 6 | 3 | 375/455/12 | 228/55 | 0.79 | 0.22 |
| 2 | 0.0038 | 0.4 | 80 | 2 | 3 | 270/525/12 | 263/55 | 2.65 | 0.65 |
| 3′ | 0.007 | 0.4 | 60 | 2 | 1 | 270/525/12 | 263/55 | 2.65 | 0.65 |
| 3 | 0.007 | 0.4 | 60 | 2 | 2 | 270/525/12 | 263/55 | 2.65 | 0.65 |
| 4 | 0.0054 | 0.5 | 70 | 4 | 2 | 325/488/12 | 245/55 | 1.25 | 0.33 |
| 5 | 0.0054 | 0.5 | 70 | 4 | 2 | 325/488/12 | 245/55 | 1.25 | 0.33 |
| 6 | 0.007 | 0.4 | 80 | 6 | 1 | 270/525/12 | 263/55 | 1.18 | 0.22 |
| 7 | 0.0038 | 0.6 | 80 | 2 | 1 | 375/455/12 | 228/55 | 2.36 | 0.65 |
| 8 | 0.0054 | 0.5 | 70 | 4 | 2 | 325/488/12 | 245/55 | 1.25 | 0.33 |
| 9 | 0.0038 | 0.6 | 60 | 6 | 3 | 375/455/12 | 228/55 | 0.79 | 0.22 |
| 10 | 0.0038 | 0.4 | 60 | 6 | 1 | 270/525/12 | 263/55 | 0.88 | 0.22 |
| 11 | 0.007 | 0.6 | 60 | 2 | 1 | 375/455/12 | 228/55 | 2.36 | 0.65 |

* Center point

| | Conver- | Monomer | 15% | 4% | |
|---|---|---|---|---|---|
| | sion in | conver- | paste | aqueous | 4% aq |
| Run # | % solid | sion | viscosity | viscosity* | viscosity** |
| 1 | 40% | 62% | 6.9 cps | 4.7 cps | 4.9 cps |
| 2 | 53% | 74% | 16.1 cps | 6.6 cps | 6.7 cps |
| 3 | 58% | 82% | 18.9 cps | 9.1 cps | 8.8 cps |
| 4(center) | 50% | 75% | 11.8 cps | 5.8 cps | 6.0 cps |
| 5(center) | 50% | 75% | 11.6 cps | 5.7 cps | |
| 6 | | | | | |
| 7 | 28% | 45% | 8.8 cps | 4.8 cps | |
| 8 | | | | | |
| 9 | | | | | |
| 10 | 63% | 88% | 16.5 cps | 6.6 cps | 7.1 cps |
| 11 | 40% | 65% | 14.7 cps | 7.5 cps | 8.0 cps |

*PVOH-co-NVF
**PVOH-co-Vam (hydrolyzed at reflux temperature/2 hrs/1.2 Meq NaOH based on assumed 12 mole % incorporation)
PVOH-co-Vam ELS

| | | | Solu- | | | | |
|---|---|---|---|---|---|---|---|
| | 4% | | bility | InsoL | Amine* | Amine** | Amine*** |
| Run # | color | odor | (RT) | gel | mole % | mole % | mole % |
| 1 | | no | | | 8.3 | | |
| 2 | | no | | | 9.5 | | |
| 3 | | no | | | 8.1 | | |
| 4(center) | | no | | | 9.6 | | |
| 5(center) | | | | | | | |
| 6 | | | | | | | |
| 7 | | slight | | | | | |
| 8 | | | | | | | |
| 9 | | | | | | | |
| 10 | | no | | | 9.1 | | |
| 11 | | no | | | 10.3 | | |

*by titration with methyl orange
**by titration with bromophenol
***by NMR ( from A. Sanford, Ticona)

It should be understood, of course, that the foregoing relates to preferred embodiments of the invention and that modifications may be made without departing from the spirit and scope of the invention as set forth in the following claims.

We claim:

1. A water-soluble copolymer formed by copolymerizing:
(a) from 99 to 1 mol % of N-vinylformamide and
(b) from 1 to 99 mol % of one or more vinyl C₁-C₁₀ alkyl esters, and then hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer has a unimodal molecular weight distribution as evidenced by essentially one peak in a gel permeation gradient elution chromatographic analysis.

2. The water-soluble copolymer of claim 1, wherein a 4% solution of the copolymer has an APHA color value of less than or equal to about 100 APHA units determined according to ASTM D1209 or a comparable method.

3. The water-soluble copolymer of claim 1, wherein a 4% solution of the copolymer has an APHA color value of less than or equal to about 50 APHA units determined according to ASTM D1209 or a comparable method.

4. The water-soluble copolymer of claim 1, wherein the copolymer is essentially free of amidine rings as evidenced by a lack of an absorption in a ¹³C NMR spectrum of the copolymer consistent with an amidine carbon atom absorption.

5. The water soluble copolymer of claim 1, wherein the vinyl C₁-C₁₀ alkyl esters are vinyl acetate, vinyl propionate, or a combination thereof.

6. The water soluble copolymer of claim 1, comprising from about 0.5 mol % to about 20 mol % amine functional groups.

7. The water soluble copolymer of claim 1, comprising from about 5 mol % to about 15 mol % amine functional groups.

8. The water soluble copolymer of claim 1, wherein a 4 wt % aqueous solution of the copolymer at 20° C. has a turbidity of less than about 100 turbidity units.

9. The water soluble copolymer of claim 1, wherein a 4 wt % aqueous solution of the copolymer at 20° C. has a turbidity of less than about 50 turbidity units.

10. A water-soluble copolymer formed by copolymerizing:
(a) from 99 to 1 mol % of N-vinylformamide and
(b) from 1 to 99 mol % of one or more vinyl C₁-C₁₀ alkyl esters, and then hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer has a unimodal molecular weight distribution as evidenced by a 4 wt % aqueous solution having a turbidity of less than about 100 turbidity units.

11. The water-soluble copolymer of claim 10, wherein a 4% solution of the copolymer has an APHA color value of less than or equal to about 100 APHA units determined according to ASTM D1209 or a comparable method.

12. The water-soluble copolymer of claim 10, wherein a 4% solution of the copolymer has an APHA color value of less than or equal to about 50 APHA units determined according to ASTM D1209 or a comparable method.

13. The water-soluble copolymer of claim 10, wherein the copolymer is essentially free of amidine rings as evidenced by a lack of an absorption in a ¹³C NMR spectrum of the copolymer consistent with an amidine carbon atom absorption.

14. The water soluble copolymer of claim 10, wherein the vinyl C₁-C₁₀ alkyl esters are vinyl acetate, vinyl propionate, or a combination thereof.

15. The water soluble copolymer of claim 10, comprising from about 0.5 mol % to about 20 mol % amine functional groups.

16. The water soluble copolymer of claim 10, comprising from about 5 mol % to about 15 mol % amine functional groups.

17. A water-soluble copolymer formed by copolymerizing
(a) from 99 to 1 mol % of N-vinylformamide and
(b) from 1 to 99 mol % of one or more vinyl C₁-C₁₀ alkyl esters, and then hydrolyzing from 30 to 100 mol % of the formyl groups from the copolymerized units (a) to form amino groups and from 30 to 100 mol % of the C₁-C₁₀ alkyl ester groups from the copolymerized units (b) to form hydroxyl groups, wherein the copolymer is essentially free of amidine rings as evidenced by a lack of an absorption in a ¹³C NMR spectrum of the copolymer consistent with an amidine carbon atom absorption.

18. The water-soluble copolymer of claim 17, wherein a 4% solution of the copolymer has an APHA color value of less than or equal to about 100 APHA units determined according to ASTM D1209 or a comparable method.

19. The water-soluble copolymer of claim 17, wherein a 4% solution of the copolymer has an APHA color value of less than or equal to about 50 APHA units determined according to ASTM D1209 or a comparable method.

20. The water soluble copolymer of claim 17, wherein the vinyl C₁-C₁₀ alkyl esters are vinyl acetate, vinyl propionate, or a combination thereof.

21. The water soluble copolymer of claim 17, comprising from about 0.5 mol % to about 20 mol % amine functional groups.

22. The water soluble copolymer of claim 17, comprising from about 5 mol % to about 15 mol % amine functional groups.

23. The water soluble copolymer of claim 17, wherein a 4 wt % aqueous solution of the copolymer at 20° C. has a turbidity of less than about 100 turbidity units.

24. The water soluble copolymer of claim 17, wherein a 4 wt % aqueous solution of the copolymer at 20° C. has a turbidity of less than about 50 turbidity units.

25. A process to produce a water-soluble copolymer comprising the steps of:
a) charging a first portion of a total amount of N-vinylformamide into a reactor;
b) charging a first portion of a total amount of at least one vinyl C₁-C₁₀ alkyl ester into the reactor;
c) continuously feeding a first portion of a total amount of a free radical polymerization catalyst at a first catalyst flow rate into the reactor;
d) contacting the first portion of N-vinylformamide, the first portion of at least one vinyl C₁-C₁₀ alkyl ester, in the presence of the free radical polymerization catalyst under polymerization conditions for a first period of time;
e) after the first period of time, continuously feeding for a second period of time, a second portion of the n-vinylformamide at a n-vinylformamide flow rate into the reactor while simultaneously feeding a second portion of at least one vinyl C₁-C₁₀ alkyl ester into the reactor at an ester flow rate, while simultaneously feeding a second portion of the free radical polymerization catalyst at a second catalyst flow rate into the reactor under polymerization conditions until the total amount of the N-vinylformamide, the total amount of the vinyl C₁-C₁₀ alkyl ester, and the total amount of the free radical polymerization catalyst have been fed into the reactor;
f) followed by contacting for a third period of time, the n-vinylformamide and the at least one vinyl C₁-C₁₀ alkyl ester in the presence of the free radical polymerization catalyst in the reactor under polymerization conditions to produce an intermediate copolymer comprising polyvinyl formamide and one or more polyvinyl C₁-C₁₀ alkyl esters, wherein the third period of time expires when the solids content of the intermediate copolymer in the reactor is greater than or equal to about 20 wt % and less than or equal to about 70 wt %; followed by
g) saponifying the copolymer to produce polyvinyl alcohol-co-vinyl formamide
h) hydrolyzing the intermediate copolymer under either acidic or basic conditions to produce the water soluble copolymer.

26. The process of claim 25, wherein the water-soluble copolymer comprises:
(a) from about 0 to 30 mol % N-vinylformamide moieties;
(b) from about 99 to 1 mol % of N-vinylamine moieties
(c) from about 0 to 30 mol % of one or more vinyl C₁-C₁₀ alkyl ester moieties; and
(d) from 1 to 99 mol % of vinyl alcohol moieties,
wherein the copolymer has a unimodal molecular weight distribution as evidenced by essentially one peak in a gel permeation gradient elution chromatographic analysis.

27. The process of claim 25, wherein water-soluble copolymer comprises:
(a) from about 0 to 30 mol % N-vinylformamide moieties;
(b) from about 99 to 1 mol % of N-vinylamine moieties
(c) from about 0 to 30 mol % of one or more vinyl C₁-C₁₀ alkyl ester moieties; and
(d) from 1 to 99 mol % of vinyl alcohol moieties,
wherein the copolymer has a unimodal molecular weight distribution as evidenced by a 4 wt % aqueous solution having a turbidity of less than about 100 turbidity units.

28. The process of claim 25, wherein water-soluble copolymer comprises:
(a) from about 0 to 30 mol % N-vinylformamide moieties;
(b) from about 99 to 1 mol % of N-vinylamine moieties
(c) from about 0 to 30 mol % of one or more vinyl C₁-C₁₀ alkyl ester moieties; and
(d) from 1 to 99 mol % of vinyl alcohol moieties,
wherein the copolymer is essentially free of amidine rings as evidenced by a lack of an absorption in a ¹³C NMR spectrum of the copolymer consistent with an amidine carbon atom absorption.

29. The process of claim 25, wherein the free radical polymerization catalyst comprises at least one member selected from the group consisting of peroxides, redox catalysts, and azo compounds which decompose to give free radicals.

30. The process of claim 25, wherein the copolymerization is carried out in a solvent or diluent.

31. The process of claim 25, wherein the copolymerization is carried out in an aqueous solution.

32. The process of claim 25, wherein said hydrolysis is carried out by contacting the intermediate copolymer with an acid.

33. The process of claim 25, wherein said hydrolysis is carried out by contacting the intermediate copolymer with a base.
